(19) United States
(12) Patent Application Publication
(10) Pub. No.: US 2006/0132612 A1
(43) Pub. Date: Jun. 22, 2006

(54) Motion picture taking apparatus and method

(76) Inventor: Hideo Kawahara, Hatogaya-shi (JP)

Correspondence Address: MORGAN & FINNEGAN, L.L.P., 3 WORLD FINANCIAL CENTER, NEW YORK, NY, 10281-2101, US

(21) Appl. No.: 11/286,016

(22) Filed: Nov. 22, 2005

(30) Foreign Application Priority Data
Nov. 26, 2004 (JP) 2004-341815(PAT.)
Dec. 15, 2004 (JP) 2004-363393(PAT.)

(51) Int. Cl. H04N 5/228

(52) U.S. Cl. 348/208.6

(57) ABSTRACT

A motion picture taking apparatus includes an image pickup device for taking plural images at a predetermined period, a memory for storing the plural images, a shake compensation amount detector for detecting a shake compensation amount for each of the plural images, an image synthesizer for compensating shakes among the plural images read out from the memory based on the shake compensation amount and for generating a synthesized image, and a signal processor for continuously outputting the synthesized image at the predetermined period.

### BACKGROUND OF THE INVENTION

The present invention relates to a motion picture taking apparatus, such as a video camera, which outputs a taken image continuously at a predetermined repetitive period, such as a field period, and more particularly to a motion picture taking apparatus and method for taking plural images at a predetermined period, for superposing and synthesizing plural images following shake compensations, and for generating one synthesized image of a motion picture.

A conventional camera system, such as a video camera, which can take a motion picture, has sought an automation and multifunction in all respects, as seen in the auto exposure (AE) and autofocus (AF) functions, for easy and excellent photographing. More recently, a miniaturization of an image taking apparatus and a higher magnification of an optical system have been promoted, and the degradation of taken images caused by vibrations of the apparatus tends to be problematic. Various shake compensation functions have been proposed as one shake compensation measure of a taken image caused by the apparatus's vibrations. An image-taking apparatus that includes such a shake compensation function provides more excellent and easier photographing.

For example, the proposed shake compensation function in the video camera is a so-called optical shake compensation system that optically compensates shakes (see, for example, Japanese Patent Application, Publication No. 9-181959), and an electronic shake compensation system that compensates shakes through electric processing (see, for example, Japanese Patent Application, Publication No. 10-178582).

Referring now to FIGS. 8A to 8C, a description will be given of an overview of the electric shake compensation. In FIGS. 8A to 8C, an area labeled 100 denotes an overall image-taking area of an image pickup device, such as a CCD sensor and a CMOS sensor. An area labeled 101 within a broken line is a cutout frame that converts into and outputs a standard video signal as an image signal (or taken image) in the overall image-taking area 100. 102 denotes a main subject which a photographer is taking. FIG. 8C shows an image on a monitor in accordance with the standard video signal.

In FIG. 8C, 103 denotes a monitor's image area that reproduces the video signal, and 102′ denotes a main subject reproduced on the monitor. The monitor reproduces the image area 103 by outputting, as a standard video signal, part of the overall area 100 obtained by the image pickup device, which removes the periphery.

Referring now to FIG. 8B that shows changes of an image when a photographer that is taking the subject 102 shakes the video camera in the lower left directions labeled arrows 104, 104′ and 104″, the main subject 102 moves in the upper right direction labeled an arrow 105 in the overall image-taking area 100 of the image pickup device. If a cutout frame labeled 101′ at the same position (or the same coordinate position on the overall image-taking area 100 surface) as the cutout frame 101 shown in FIG. 8A is used to cut out in this state, then the cutout frame 101′ produces a video signal that reflects a movement of the main subject 102 by a vector amount shown by the arrow 105.

If a shake amount of the video camera is detected when the image pickup device takes an image, and a displacement amount 106 of an image calculated from the shake amount or a shake compensation target value is used to move the cutout frame position 101′ to the frame position indicated by broken line 101″, the shake caused movement of the object 102 image is canceled and the image shown in FIG. 8C can be obtained. The electronic shake compensation uses this principle to compensate a shake of an image. More specifically, an electric correction to shakes of the image-taking means compensates shakes of a motion picture, and enables less shifted images to be taken.

Referring to FIG. 9, a brief description will be given of a video camera that includes the above electronic shake compensation means. The photographing light incident through a lens 150 in the optical system images on an image pickup device 151, such as a CCD, and is converted into a charge or electronic signal. The electric signal is read out from the image pickup device 151 based on the readout signal at a predetermined timing from a timing generator (TG) 152, converted by a signal processor 153 into a standard video signal, such as NTSC, and output from a video output terminal 154.

An angular velocity sensor 155, such as a vibration gyro, detects a shake of the video camera as an angular velocity in accordance with the photographing timing, and calculates a shake compensation amount through a shake compensation amount operator 156 that includes a DC cut filter, an amplifier, and an integration circuit (not shown).

More specifically, the DC cut filter extracts the AC or vibration component out of each input speed signal, the amplifier amplifies the component, and the integration circuit converts the angular velocity into an angular displacement through an integration process. The shake compensation amount is calculated based on the obtained angular displacement. A readout position controller 157 converts the calculated shake compensation amount into a pixel moving amount of the image pickup device 151. A readout or cutout position is changed based on the moving amount, and the readout timing of the image pickup device 151 is changed based on the shake compensation amount.

The conventional optical shake compensation system also uses the same angular velocity sensor, DC cut filter, amplifier, and integration circuit for the shake compensation detecting means, as those in the above electronic shake compensation system, and the shake compensation operator 156 calculates an angular displacement. The optical shake compensation system characteristically displaces the optical axis based on the angular displacement, cancels the shake. For example, one proposed system displaces the optical axis of the input light upon the image pickup device by displacing the shake compensation lens within the plane orthogonal to the optical axis.

The optical cancellation of the shake of the video camera always secures the optical shake compensation during photographing or exposure, and provides a non-shifted, taken image.

However, the video camera having the electronic shake compensation means is disadvantageous in the shake compensation accuracy, because no shake compensation is available during the charge accumulating time during the exposure period of the image pickup device 151.

As the miniaturization of the video camera and the higher magnification of the optical system are likely to advance, the instant inventor has studied a shortened accumulation period for purpose of a reduced shake during an exposure period and for a further improvement of the compensation accuracy. The compensation accuracy improves as the shaking influence reduces during the exposure period, but this improvement may result in unnaturally small movements of the subject in the video motion picture.

One conceivable example of this problem is a crossing car in the background of a subject. Although the main subject and the background are compensated by the electronic shake compensation, the shake or movement of the crossing car in the background also reduces or mitigates as the exposure period is shortened. As a result, the motion picture loses the car's smooth movement and a static car suddenly appears at a position corresponding to the locus of the car for each field.

If the number of obtained images is increased to reproduce the smooth movement of the car, the data amount becomes enormous, causing a shortened photographable period unless a large capacity storage is loaded.

In addition, the optical shake compensation system supports a compensation lens, drives the lens precisely, and thus has a limit of miniaturization.

### BRIEF SUMMARY OF THE INVENTION

Accordingly, it is one exemplary object of the present invention to provide a motion picture taking apparatus and method for compensating a shake of a taken image without lowering the reproducibility of a continuous movement of a moving subject during a motion picture taking time period that outputs an image at a predetermined repetitive output, such as a field period.

A motion picture taking apparatus according to one aspect of the present invention includes an image pickup device for taking plural images at a predetermined period, a memory for storing the plural images, a shake compensation amount detector for detecting a shake compensation amount for each of the plural images, an image synthesizer for compensating shakes among the plural images read out from the memory based on the shake compensation amount and for generating a synthesized image, and a signal processor for continuously outputting the synthesized image at the predetermined period.

A motion picture taking method according to one aspect of the present invention includes a taking step of taking plural images at a predetermined period, a storing step of storing the plural images in a memory, a shake compensation amount detecting step of detecting a shake compensation amount for each of the plural images, an image synthesizing step of compensating shakes among the plural images read out from the memory based on the shake compensation amount and of generating a synthesized image, and a signal processing step of continuously outputting the synthesized image at the predetermined period.

Other objects and further features of the present invention will become readily apparent from the following description of the preferred embodiments with reference to the accompanying drawings.

### BRIEF DESCRIPTION OF THE DRAWINGS

FIG. 1 is a block diagram of a schematic structure of a camera system according to a first embodiment of the present invention.

FIG. 2 is a view of a shake compensation amount operator in the camera system.

FIG. 3 is a flowchart showing an operation of the shake compensation amount operator.

FIG. 4 is a timing chart showing an operational timing of the camera system.

FIG. 5 is a schematic view showing an image at the shake compensation time and a synthesized image in the camera system.

FIG. 6 is a view for explaining an image cutout at the anti-shake time.

FIG. 7 is a block diagram of a schematic structure of a camera system according to a second embodiment of the present invention.

FIGS. 8A to 8C are schematic views of electronic anti-shake.

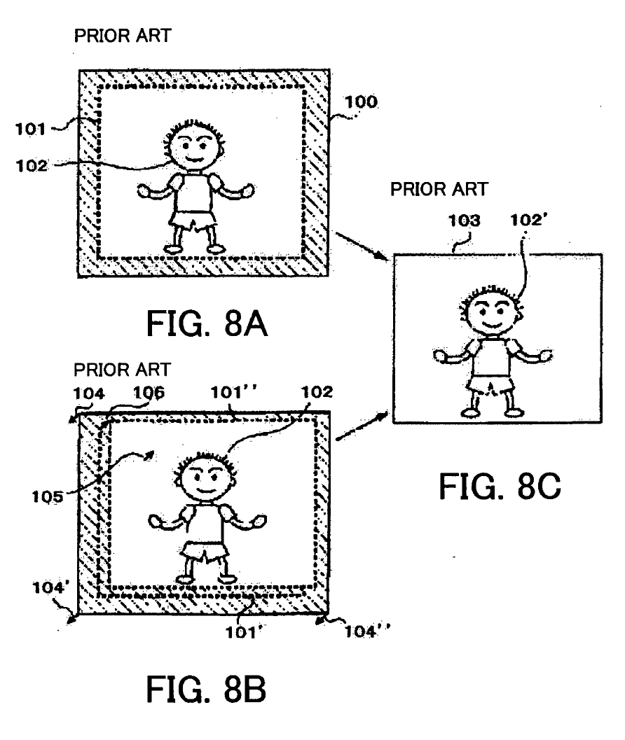

FIG. 9 is a view of a structure of a conventional camera system.

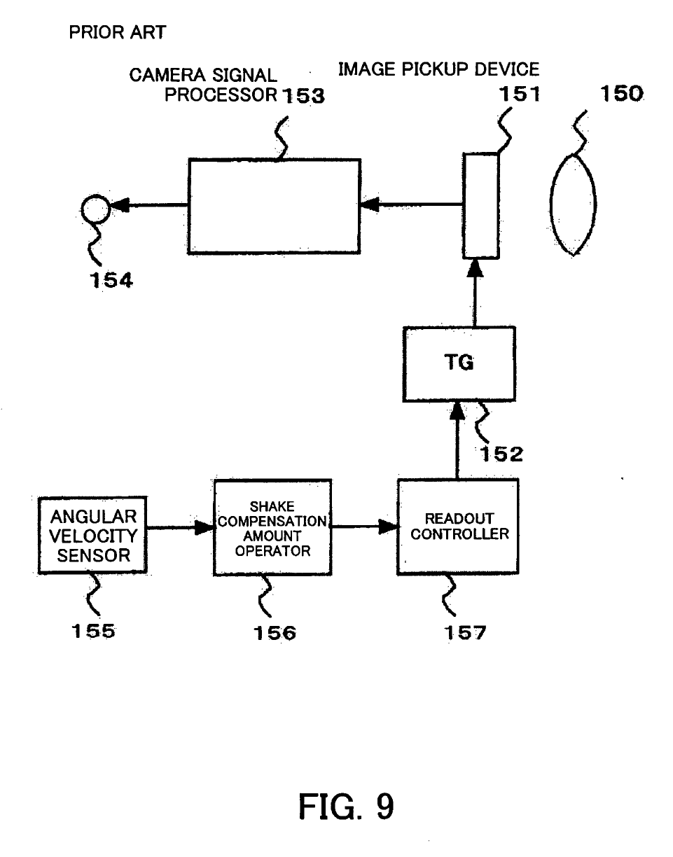

### DETAILED DESCRIPTION OF THE PREFERRED EMBODIMENTS

Referring to the accompanying drawings, a description will be given of the preferred embodiments.

### First Embodiment

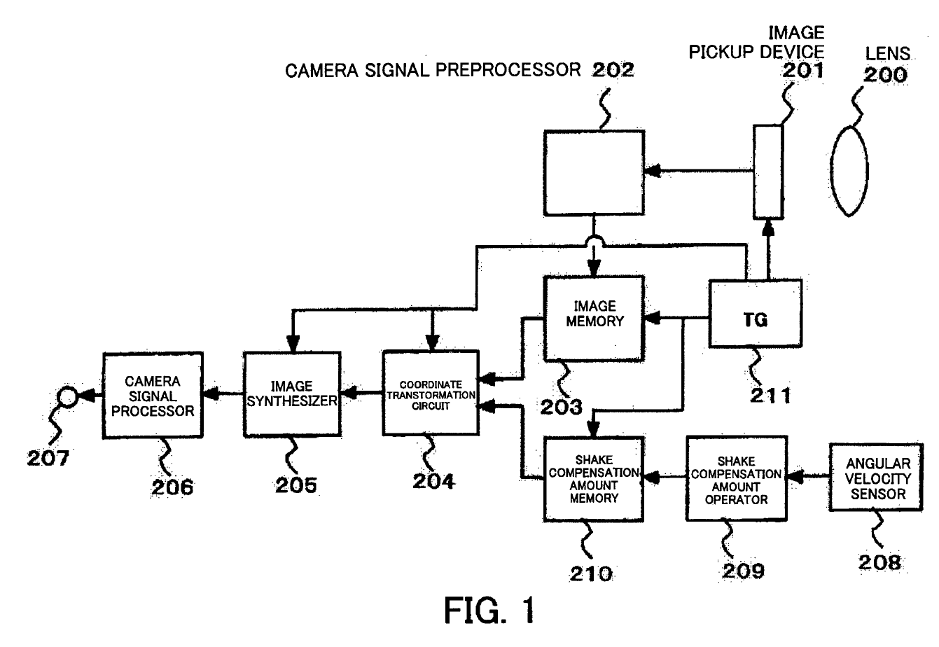

A description will now be given of a first embodiment of the present invention. FIG. 1 is a block diagram showing a schematic structure of the camera system (as a motion picture taking apparatus) of this embodiment. As illustrated, the camera system includes, as an image taking part, 200 that denotes a lens that constitutes part of an optical system, and is detachably attached to a camera body. 201 denotes an image pickup device as a photoelectric conversion element, such as a CCD sensor and a CMOS sensor. 202 denotes a camera signal preprocessor that converts an electric signal from the image pickup device 201 to an image signal.

203 denotes an image memory that stores an image signal or data output from the camera signal preprocessor 202. 204 denotes a coordinate transformation circuit or part that transforms a two-dimensional coordinate of an image signal read out from the image memory 203 for a shake compensation.

205 denotes an image synthesizer or image synthesizing means that synthesizes image signals that are obtained at different timings and have coordinates transformed by the coordinate transformation circuit 204. 206 denotes a camera signal processor or signal processing means that converts a synthesized image signal into a standard video signal, such as NTSC. A video output terminal 207 is configured to output the converted standard video signal as a video image at a predetermined period or at intervals, for example, of 1/60 seconds.

Although not shown in FIG. 1, the lens 200 includes a lens unit that has plural lenses, and is driven by a driving motor, such as a vibration type motor and a stepping motor, which changes a lens interval for adjusting a zooming position, for focusing, and for varying a focal length.

The camera system includes, as a shake compensation mechanism 208 that denotes an angular velocity sensor or a shake detector, such as a vibration gyro, which detects a shake amount of the camera system and is provided on an exterior member of the camera system. 209 denotes a shake compensation amount operator or operational circuit that calculates the shake compensation amount based on the angular velocity signal or information output from the angular velocity sensor 208. 210 denotes a shake compensation amount memory or storage that stores the shake compensation amount operated by the shake compensation operator 209. The shake compensation amount detecting means includes the shake compensation detector, the shake compensation operator and the shake compensation memory.

211 denotes a timing generator (abbreviated as “TG” hereinafter) that generates a reference signal of an operational timing in the image taking apparatus, and supplies the reference signal as an activating trigger to the image pickup device 201, the image memory 203, the coordinate transformation circuit 204, the image synthesizer 205, and the shake compensation amount memory 210.

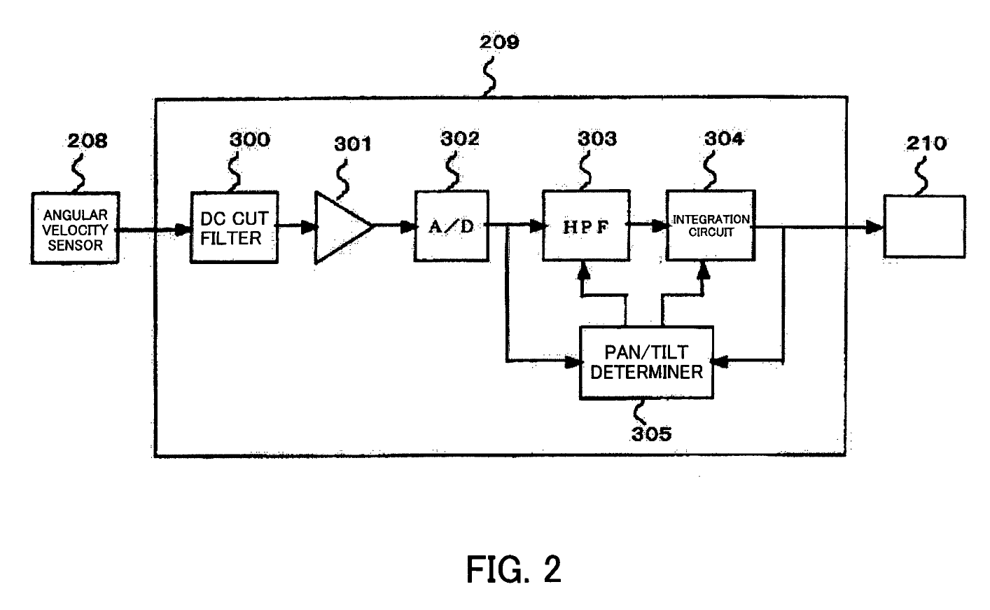

A detailed description will be given of the shake compensation amount operator 209, with reference to FIG. 2. FIG. 2 is a block diagram of an internal structure of the shake compensation amount operator 209. In FIG. 2, 300 denotes a DC cut filter in a vibration signal extractor that cuts the DC component in the angular velocity signal output from the angular velocity sensor 208, and allows the AC component or the vibration component to pass. The vibration signal extractor is not limited to the DC cut filter 300, and may use a high-pass filter (HPF) that cuts a signal of a predetermined band.

301 denotes an amplifier that amplifies the angular velocity signal that passes the DC cut filter 300 to a proper sensitivity. 302 denotes an A/D converter that converts the angular signal output from the amplifier 301 into a digital signal. 303 denotes a high-pass filter (HPF) that cuts a low frequency component in the digital output from the A/D converter 302, and serves to vary a characteristic at an arbitrary band.

304 denotes an integration circuit that integrates the angular velocity signal or information from the HPF 303, outputs an angle displacement signal, and serves to vary a characteristic at an arbitrary band. 305 denotes a pan/tilt determiner that determines whether the camera system is in the panning/tilting state based on the angular velocity signal and the angular displacement signal output from the integration circuit 304. The pan/tilt determiner 305 is configured to provide panning control, which will be described later, based on the angular velocity and displacement information (or levels of the angular velocity signal and angular displacement signal).

The panning/tilting state, as used herein, means a state at which the camera system operator photographs and manipulates the camera with intentional tilting or panning. The panning control is control that restricts a shake compensation range in this state in order to prevent the disturbance of taken images and secure the prompt responsiveness in the operator's intended direction.

The A/D converter 302, the HPF 303, the integration circuit 304, and the pan/tilt determiner 305 are actually implemented as a microcomputer and constitute a shake compensation amount operator. The angular displacement signal obtained by the shake compensation amount operator based on the angular velocity signal detected by the shake detector is used to calculate a shake compensation target value, e.g., a shake compensation amount=focal length×tan (shake compensation angle) in the subsequent control.

A detailed description of the panning control will be given below. When the angular velocity signal output from the A/D converter 302 and the angular displacement signal output from the integration circuit 304 are input to the pan/tilt determiner 305, the panning/tilting state is determined when the angular velocity is a predetermined threshold or greater, or when the angular velocity is smaller than the predetermined threshold and when the angular displacement as a result of an integration of the angular velocity signal is a predetermined threshold or grater. When there is determined the panning/tilting state, the lower-pass cutoff frequency of the HPF 303 is changed to a high-pass side, and the characteristic is changed so that the shake compensation system does not respond to the low frequency.

When there is determined the panning/tilting state, the image correcting position is gradually moved to the center of the moving range so that the time constant of the integral characteristic of the integration circuit 304 becomes shorter. The panning control follows so that the value accumulated in the integration circuit 304 becomes the reference value (that is available when no shake is detected). Detections of the angular velocity speed and the angular displacement signal continue during this period. When the panning/tilting state is released, the low cutoff frequency decreases again, an action that expands the shake compensation range follows, and the panning control ends.

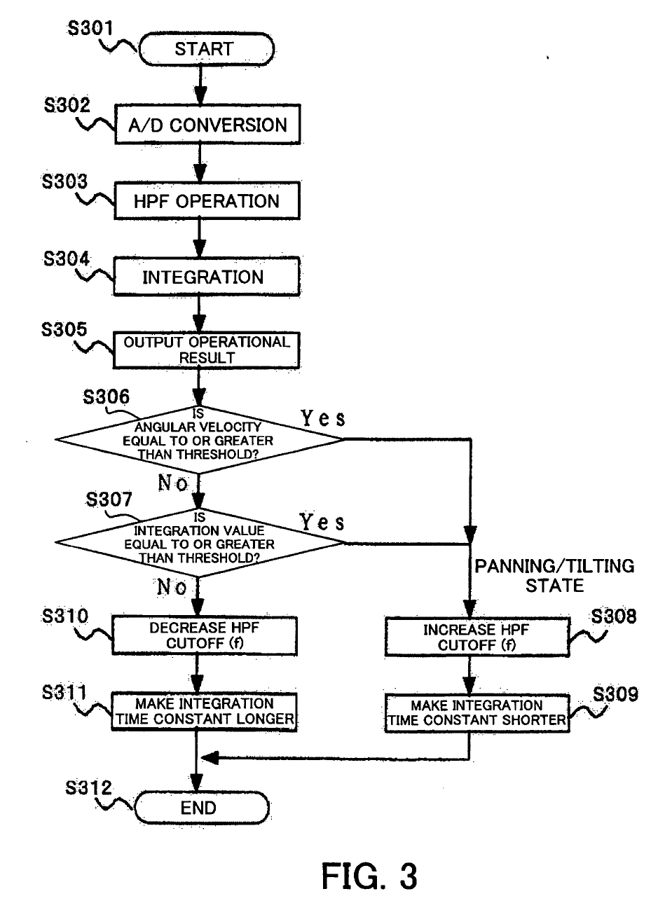

This operation will be described with reference to a flowchart shown in FIG. 3. This flowchart is implemented by a computer program installed in the shake compensation amount operator 209.

Step S301 is a start of this flow, and repeats at a predetermined timing.

Step S302 converts the amplified angular velocity signal from an analogue value to a digital value.

Step S303 uses the initial value or the previously used value of the cutoff frequency for operations of the HPF 303.

Step S304 executes the integral operation with the initial value or previously used value of the integral time constant.

Step S305 outputs a integration result or angular displacement signal.

Step S306 determines whether the angular velocity signal is equal to or greater than a predetermined value.

Step S307 determines whether the integral value is equal to or greater than a predetermined value. There is determined the panning/tilting state and the procedure proceeds with step S308, when the angular velocity is equal to or greater than the predetermined threshold or when the angular velocity is smaller than the predetermined threshold and when the angular displacement as a result of an integration of the angular velocity signal is a predetermined threshold or grater. On the other hand, when both the angular velocity signal and the integral value are smaller than the predetermined thresholds, there is determined normal control or an end of the panning/tilting state and the procedure proceeds with step S310.

Step S308 increases the value (f) of the cutoff frequency used for the operation of the HPF 303 from the current value by a predetermined value, so as to make the attenuation factor of the low frequency signal greater than the current one.

Step S309 shortens the value of the time constant used for the integration operation from the current value by a predetermined value so that the angular displacement output can be closer to the reference value.

Step S310 lowers the value (f) of the cutoff frequency used for the operation of the HPF 303 from the current value by a predetermined value, so as to make the attenuation factor of the low frequency signal smaller than the current one.

Step S311 makes the time constant used for the integration operation longer than the current value by a predetermined value, and enhances the integration effect.

Step S312 terminates the procedure. The above control prevents a saturation of the integral value=the shake compensation target value, sets the shake compensation target value to a steady state, and provides a stable shake compensation signal.

A description will now be given of an operation of each component in the above camera system. For example, in the video photographing, the light incident through the lens 200 images on the image pickup device 201, is converted into a charge or electronic signal, and accumulated. The charges accumulated in the image pickup device 201 is read out at a predetermined timing (or second period) generated plural times by the TG 211 within one field (predetermined or first period), converted into a digital signal by an A/D converter (not shown), and input into the camera signal preprocessor 202.

The camera signal preprocessor 202 performs a predetermined signal process for the input digital image signal, such as formations of a brightness signal and a color signal.

The image signal output from the camera signal preprocessor 202 is sequentially stored in the image memory 203 at the predetermined timing (or second period) generated by the TG 211. Thereby, the image signals read from the image pickup device 201 within one field period (first period) and signal-processed by the camera signal preprocessor 202 are stored in the image memory 203 at the second period generated by the TG 211.

The angular velocity sensor 208 detects a shake of the camera system in accordance with the timing at which the charge is read from the image pickup device 201, and the shake compensation amount operator 209 calculates the shake compensation amount, as discussed above. The shake compensation signal output from the shake compensation amount operator 209 is sequentially stored in the shake compensation amount memory 203 with the image signal read out from the image pickup device 201 at the synchronous timing, for example, in accordance with the predetermined or second period generated from the TG 211.

When the storage of the image signal into the image memory 203 within one field period and the storage of the shake compensation amount into the shake compensation amount memory 210 are conducted predetermined times as a result of repetitions of the above procedure, data is read, for example, at the end of the field out of the image memory 203 and shake compensation amount memory 210 and input into the coordinate transformation circuit 204.

The coordinate transformation circuit 204 transforms a coordinate of the image signal read from the image memory 203 or changes a position of the cutout area, based on the shake compensation amount read out from the shake compensation amount memory 210.

The coordinate-transformed image signal is input into the image synthesizer 205. When the image synthesizer 205 performs weighted averages for a predetermined number of images or all the image signals obtained, for example, within one field, one taken image data is produced and output from the video output terminal 207 at the first period.

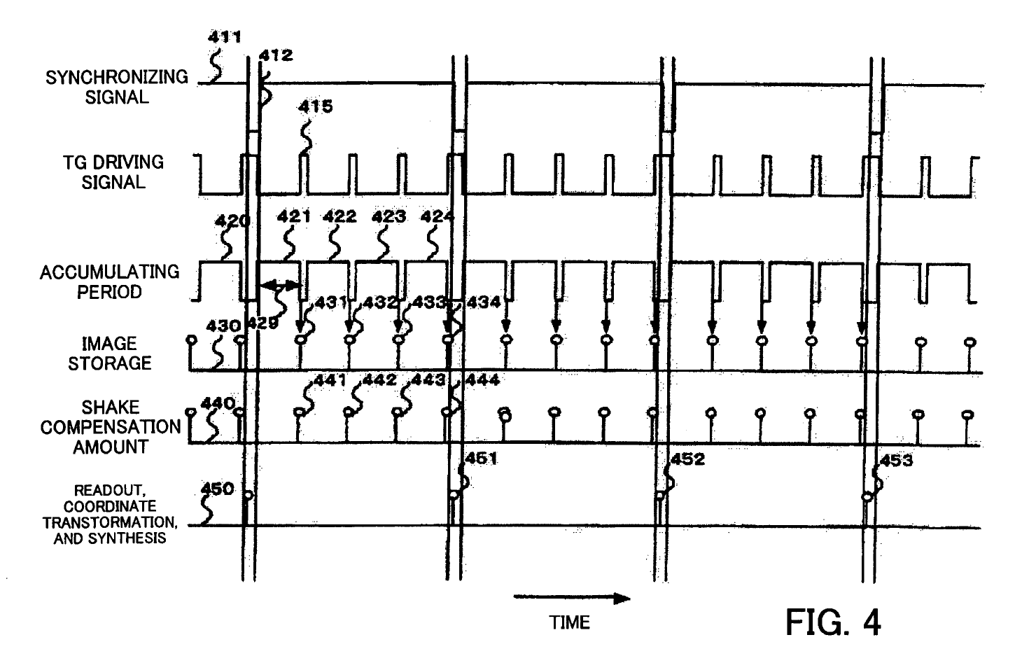

Referring now to FIG. 4, a description will be given of an exemplary timing of each of the above operations. The timing chart in FIG. 4 will now be described. In FIG. 4, 411 denotes to a synchronizing reference signal that corresponds, for example, to a perpendicular synchronizing signal of NTSC.

415 denotes a typical timing of the driving signal of the TG 211.

410 denotes an accumulating period of the image pickup device 201. A high section 429 is the accumulating period, and a low section is used to read out the accumulated information.

430 denotes a storing timing at which the image signal is read from the image pickup device 201, formed after signal-processed by the camera signal preprocessor 202, and stored in the image memory 203. This embodiment stores at timings 431, 432, 433, etc.

440 denotes a timing at which the shake compensation amount is operated from the angular velocity signal, and the value is stored in the shake compensation amount memory 210. This embodiment stores at timings 441, 442, 443, etc. 450 denotes a timing at which the stored image signal is read out, the shake compensation amount that has been stored in the contemporary, for example, synchronizing timing is read out, the image signal is coordinate-transformed based on the shake compensation amount, and all the images obtained within one field are synthesized so as to generate one taken image data. This embodiment reads, transforms a coordinate, and synthesizes images at timings 451, 452, 453, etc.

The operation will now be given along the time base. First, when a perpendicular synchronizing period 412 in the synchronizing signal 411 ends, the image pickup device 201 starts accumulating and reading based on the timing of the TG driving signal generated by the TG 211. The camera signal preprocessor 202 converts data into an image signal, and the image memory 203 stores the image signal.

When the accumulation into the image pickup device 201 is conducted, for example, at the timing 421, as in this embodiment, the reading action follows as soon as the accumulation ends based on the TG driving signal 415 and the camera signal preprocessor 202 signal-processes the signal, and the processed image signal is stored at the timing 431.

The angular velocity signal obtained from the angular velocity sensor 208 is converted into the shake compensation amount at the shake compensation amount operator 209 at the synchronous timing 441, and then stored in the shake compensation memory 210. After a predetermined of (four in this embodiment) processes, the stored image signal is read out from the image memory 203 at the timing 451 within the synchronous period of the synchronizing signal 411, and the contemporarily stored shake compensation amount is read out from the shake compensation amount memory 210. The coordinate conversion of the image signal (readout of an output image in accordance with the shake compensation amount, which will be described later) is based on the shake compensation amount.

After the coordinate transformation, the predetermined number of images or, for example, all the image signals within one field (or four image signals in this embodiment) are synthesized to generate one taken image data.

As discussed, each image signal taken into the image memory 203 obtained from plural captures during the field period can mitigate the shaking influence when the image signal is being accumulated, by dividing one field period and obtaining an image signal for each divided period or by the shortened accumulating time period based on the number of captures. More specifically, when the accumulation period is quartered by obtaining four images within one field period as in this embodiment, the shift amount of the image is also quartered.

However, when these images are synthesized, the composition among the images of the synthesized image shifts by a moving amount due to shaking etc.

Therefore, the synthesis needs to correct the shift among images. This embodiment corrects the shift among images through the coordinate transformation of the images, as detailed below.

While this embodiment provides four accumulations (at the second period) and readouts within one field (or one synchronous or first period), the above number may be two or greater, and is not limited to four times. Moreover, part of the obtained image data may be synthesized instead of synthesizing all the image signals within each field.

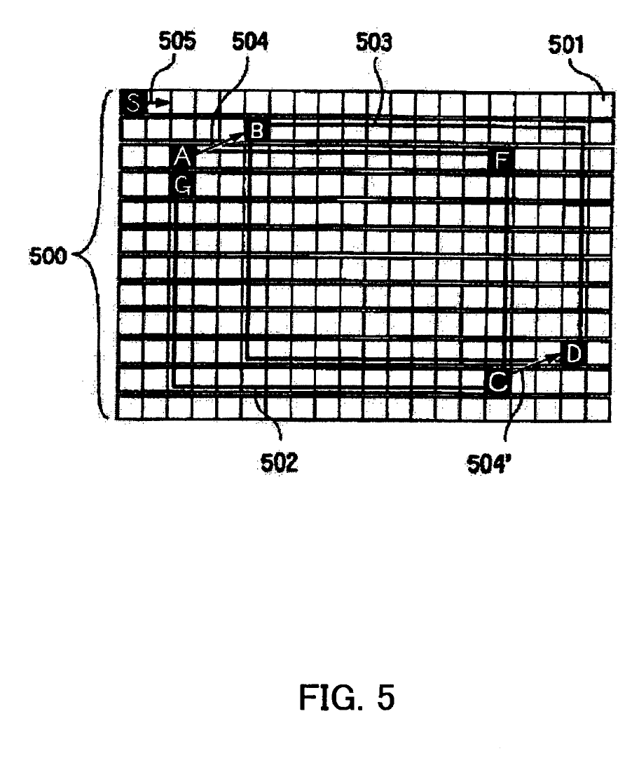

Referring now to FIG. 5, a description will be given of the coordinate transformation of the image signal. 500 denotes the entire area of the image stored in the image memory 203, and has a pixel configuration corresponding to the overall image-taking area (or entire image-taking surface) of the image pickup device 201, which arranges each photoelectric conversion element (or image taking element) that constitutes a pixel unit in a plane like a lattice. The image memory 203 sequentially stores a read image based on an electric driving pulse generated from the TG 211.

As illustrated, areas labeled 502, 503 denote cutout frames in outputting a video signal. The overall image-taking area 500 is not output as a video signal as it is, only the area cut by the cutout frame 502 or 503 out of the overall image-taking area 500 is output as a video signal of the taken image.

A description will now be given of an exemplary cutout of a video signal, for example, with a cutout frame labeled 502 in FIG. 5. In reading an image stored in the image memory 203 based on the signal from the TG 211, the memory image is first read in order from a pixel labeled “S” in an arrow 505 direction. The readout starts up to a pixel just prior to the pixel labeled “A” during the synchronous period of the output video signal, for example, at a speed faster than the regular reading speed.

During a real video period after the synchronous period ends, charges of the pixel labeled “A” in the cutout frame 502 to the pixel “F” are read as one line image information of the video signal, for example, at a regular reading speed.

In addition, during a horizontally synchronizing period to the next one line, pixels from “F” to “G” are read at a speed faster than the regular reading speed, and one line is read from “G” at the regular reading speed similar to the readouts from “A” to “F.” By thus controlling the readout timing, the area corresponding to the cutout frame 802 is selectively taken out of the overall image-taking area 500 and output as a video signal of a taken image.

When the camera system shakes, for example, when a movement of the subject (which is a shake of the camera system) occurs in the overall image-taking area 500 by an amount labeled an arrow 504, a taken image that maintains the subject is obtained if the cutout frame is changed to a position shown by the cutout frame 503.

More specifically, in order to change the cutout frame position, the pixel 's readout start position is moved from “A” to “B,” an image is selectively taken out of the cutout frame 503 in the overall photographing image 500 and output as a video signal, similar to the cutout frame 502.

Thus, all the pixels read from the image pickup device 201 are stored in the image memory 203, and the peripheral partial image-taking area is previously read by an amount corresponding to the shake compensation information during the synchronizing signal period that does not appear in the real video period. In addition, part of the image pickup device 201 is selectively read based on the shake compensation amount of the camera system. This configuration provides a video signal that removes the image fluctuations associated with the shake of the camera system.

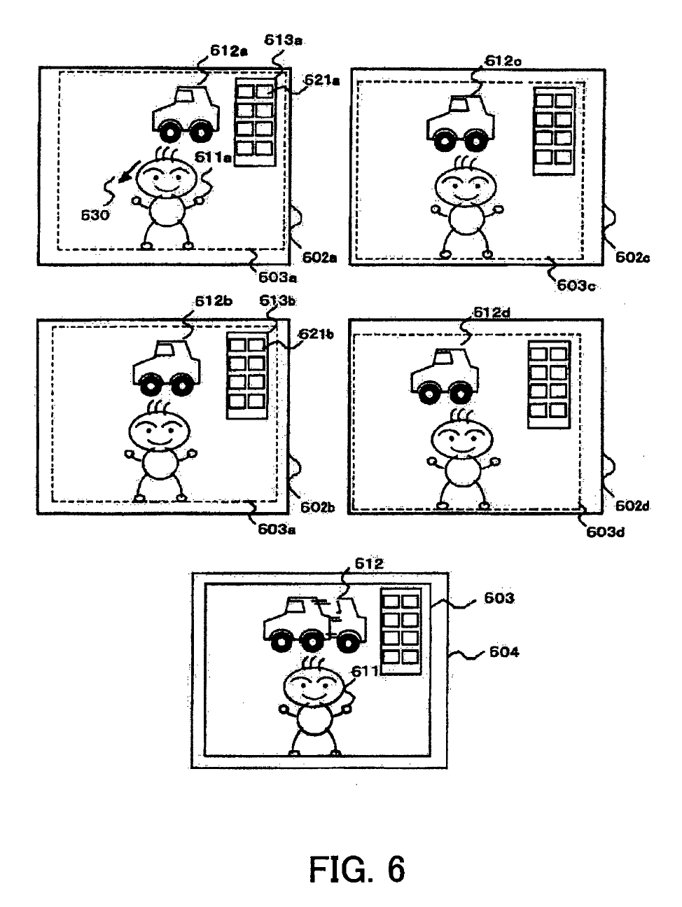

For better understandings of the shake compensation of an image and an image synthesis, a more detailed description will be given by using an image schematically shown in FIG. 6. In FIG. 6, 602a, 602b, 602c and 602d are plural image signals (or overall image-taking surface 500) that are taken at regular intervals within one field as the first period. For example, within accumulating periods 421, 422, 423 and 424 in FIG. 4, the image signals are taken in order of 602a, 602b, 602c and 602d, and stored in the image memory 203.

As illustrated, 611a denotes a main subject or person. 612a (612b, 612c, 612d) denotes a moving subject, such as a car. 613a (613b) denotes a building. 621a (621b) denotes a window. An arrow 630 shows a moving direction of the image, which occurs due to the rotational shift of the image taking apparatus.

In other words, when camera shakes in the arrow direction 603, the video signals 602a to 602d are obtained.

When the above shake compensation signal is addressed, the desired shake compensation signal is obtained in a shaking direction of the camera system or the arrow 630 direction. Therefore, a moving or shift amount caused by shakes of the camera system for each image signal can be corrected by moving coordinates of the taken image signals 602a (602b, 602c, 602d) based on the shake compensation amount corresponding to each of the image signals 602a (602b, 602c, 602d). Thereby, the shake amount of each image signal can be corrected.

In other words, a moving amount caused by shakes of the camera system can be cancelled through the coordinate transformations into the same coordinates of the areas indicated by broken lines of respective image signals 603a, 603b, 603c, and 603d.

When the corrected image signals 603a, 603b, 603c and 603d are superposed and synthesized, the frame (taken) image is formed as the synthesized image signal 604. Specific methods of superposing images contain a method of adding brightness and color data of the same coordinate point on the image and dividing it by the number of additions, and a method of previously limiting the light intensity at the image-taking time to 1 divided by the number of accumulations within one frame and of simply adding it.

In the thus synthesized image signal 604, the main subject 611 and the background are stationary. On the other hand, the moving subject 612 causes a shifted image (or a fluctuating image in accordance with the motion of the subject itself) as a result of the superposition by the image synthesizer 205. Thus, this embodiment can reduce shifts of the taken images due to the shakes of the image-taking apparatus, and reproduce a smooth motion of the moving subject.

According to this embodiment, the camera system obtains plural image signals at the second period shorter than the first period that is used to output the taken image, compensates a shake for each image signal, and superposes and synthesizes compensated image signals into one taken image. This configuration compensates a shake of a taken image without lowering the reproducibility of the smooth motion of the subject.

In addition, a synthesis of shake-compensated images is extremely unlikely to cause a shifted static image of a subject that hardly moves, such as a building.

### Second Embodiment

A description will be given of a second embodiment of the present invention.

While the first embodiment uses the angular velocity sensor 208, and the shake compensation amount operator 209 to detect the shake compensation amount of the image, this embodiment is characterized in detecting moving amounts among images by extracting a feature point of each taken image.

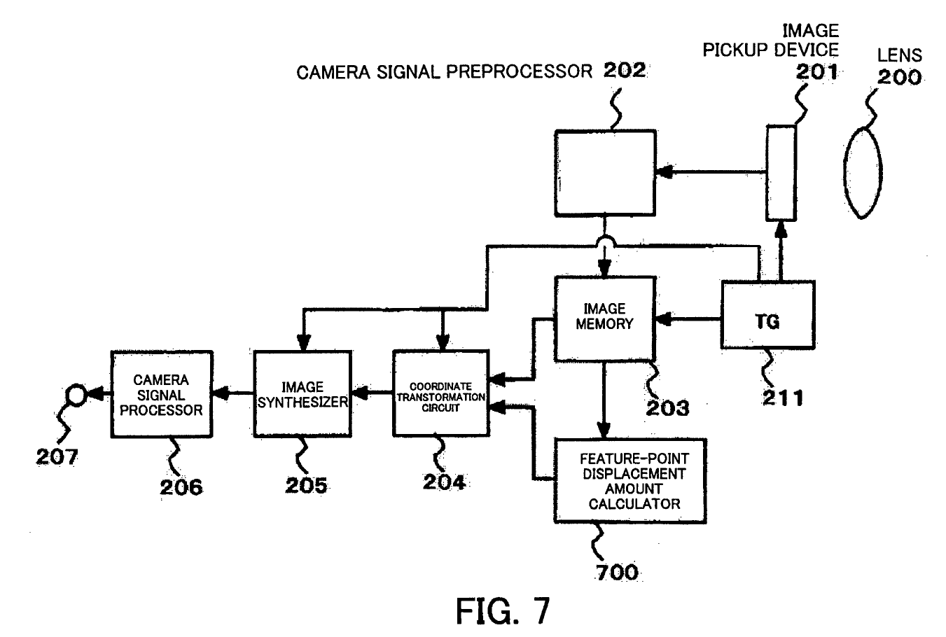

FIG. 7 is a block diagram of a schematic structure of the image taking apparatus of this embodiment. As illustrated, 700 denotes a feature-point displacement amount calculator or part, which calculates a moving amount, for example, between two images through a coordinate change of a feature point included in an image as detailed later. Those elements, which are corresponding elements in the first embodiment are designated by the same reference numerals, and a detailed description thereof will be omitted.

A description will now be given of an operation of each component. The incident (photographing) light through the lens 200 images on the image pickup device 201, is converted into a charge or electric signal, and accumulated. The charge accumulated in the image pickup device 201 is read out at a predetermined timing or second period that occurs plural times within one field period or first period generated by the TG 211, and input into the camera signal preprocessor 202 after converted into the digital signal, for example, by the A/D converter (not shown).

The camera signal preprocessor 202 performs predetermined signal processing for the input digital image signal, such as formations of a brightness signal and a color signal, and sequentially stores it in the image memory 203 at the predetermined timing (or second period) generated by the TG 211. Thereby, the image signals read from the image pickup device 201 within one field period and signal-processed by the camera signal preprocessor 202 are stored in the image memory 203 at the predetermined timing (second period) generated by the TG 211.

Referring now to FIG. 6, a description will be given of the detection of the shift amount of the image by the feature-point displacement amount calculator 700. The image signal read out from the image memory 203 is input into the feature-point displacement amount calculator 700, which extracts a feature point.

More specifically, for example, an edge of a window 621a as a point having high brightness is taken as a feature point out of a building 613a in an image signal 601a, the feature point and a feature point 641b in the next continuous image signal 601b are compared with each other, and a difference of a two-dimensional position is corrected (coordinate conversion).

For convenience, this embodiment discusses only one feature point, but plural feature points can actually exist within one image signal. The coordinate moving amount can be calculated through averaging of feature-point shift amounts based on the information, and the coordinate transformation may be provided.

In general, more feature points are preferable, because a more static background enables only the movement of the shaken image to precisely extracted.

While this embodiment discusses a coordinate conversion between two image frames, the actual photographing is continuous and the coordinate conversions of all the image signals are available by repeating the similar coordinate transformations for two or more image signals. The above feature-point extraction provides an image signal 's positional correcting amount for the shaken image or shake compensation signal.

After a completion of the storages of taken images into the image memory 203 within one field the predetermined number of times, the image memory 203 reads an image signal and inputs it into the feature-point displacement amount calculator 700. As discussed above, the feature-point displacement amount calculator 700 extracts the feature point from the continuous image signal, and calculates the shake compensation amount using a difference of the coordinate.

On the other hand, the image signal read by the image memory 203 is input to the coordinate transformation circuit 204, and the coordinate is transformed based on the shake compensation amount calculated by the feature-point displacement amount calculator 700. The coordinate-transformed images are input into the image synthesizer 205, receive a weighted average for the predetermined number of images, and are synthesized.

The synthesized taken image is output from the video output terminal 207. Thus, this embodiment reduces a shift of the taken image due to the shakes of the camera system, and reproduces a smooth motion of the moving subject.

As discussed, according to each of the above embodiments, the image taking apparatus that outputs a taken image continuously at a predetermined period takes plural images during the predetermined period, compensates a shake of an image based on a shake amount of each image, superposes and synthesizes at least two shake compensation image data into one image, compensating a shake of a taken image without lowering the reproducibility of the continuous motion of the subject.

This application claims foreign priority benefit based on Japanese Patent Applications Nos. 2004-363393 filed on Dec. 15, 2004 and 2004-341815 filed on Nov. 26, 2004, each of which is hereby incorporated by reference herein in its entirety as if fully set forth herein.

What is claimed is:

1. A motion picture taking apparatus comprising:
an image pickup device for taking plural images at a predetermined period;
a memory for storing the plural images;
a shake compensation amount detector for detecting a shake compensation amount for each of the plural images;
an image synthesizer for compensating shakes among the plural images read out from said memory based on the shake compensation amount and for generating a synthesized image; and
a signal processor for continuously outputting the synthesized image at the predetermined period.

2. A motion picture taking apparatus according to claim 1, wherein said shake compensation amount detector includes:
a shake detector for detecting a shake amount of said motion picture taking apparatus;
a shake compensation amount operator for operating the shake compensation amount based on the shake amount that has been detected; and
a shake compensation amount memory for storing the shake compensation amount that has been operated while correlating the shake compensation amount with each of the plural images.

3. A motion picture taking apparatus according to claim 1, wherein said shake compensation amount detector includes a displacement amount operator for operating the shake compensation amount of each image based on a displacement amount of a feature point of each image.

4. A motion picture taking apparatus according to claim 1, wherein a charge accumulating period of said image pickup device is determined based on the number of images taken at the predetermined period.

5. A motion picture taking method comprising:
a taking step of taking plural images at a predetermined period;
a storing step of storing the plural images in a memory;
a shake compensation amount detecting step of detecting a shake compensation amount for each of the plural images;
an image synthesizing step of compensating shakes among the plural images read out from the memory based on the shake compensation amount and of generating a synthesized image; and
a signal processing step of continuously outputting the synthesized image at the predetermined period.
